(19) United States
(12) Patent Application Publication
(10) Pub. No.: US 2013/0043344 A1
(43) Pub. Date: Feb. 21, 2013

(54) HIGH-STRENGTH AIRCRAFT INTERIOR PANEL WITH EMBEDDED INSERT

(71) Applicants: Kevin Ruonavaara, Snohomish, WA (US); Ryan Hohensee, Camano Island, WA (US); James C. Grieve, Arlington, WA (US)

(72) Inventors: Kevin Ruonavaara, Snohomish, WA (US); Ryan Hohensee, Camano Island, WA (US); James C. Grieve, Arlington, WA (US)

(73) Assignee: B/E Aerospace, Inc., Wellington, FL (US)

(21) Appl. No.: 13/587,267

(22) Filed: Aug. 16, 2012

Related U.S. Application Data
(60) Provisional application No. 61/524,616, filed on Aug. 17, 2011.

(51) Int. Cl. B64C 1/10

(52) U.S. Cl. 244/118.1; 244/119

(57) ABSTRACT

An aircraft interior panel for supporting high-weight loads including a core panel sandwiched between structural plies, a panel insert embedded in the panel and passing through and interrupting the core panel, the insert having an elongate stem capped on each end with an enlarged flange, the elongate stem being arranged axially perpendicular to the core panel and the enlarged flanges being arranged parallel to the core panel, and facing sheets bonded outward of the panel insert for concealing the panel insert within the aircraft interior panel.

### CROSS-REFERENCE TO RELATED APPLICATION

This application claims priority to U.S. Provisional Application No. 61/524,616 filed Aug. 17, 2011, the entirety of which is incorporated by reference herein.

### TECHNICAL FIELD AND BACKGROUND OF THE INVENTION

This invention relates generally to the field of materials suitable for use in aircraft interior upfitting, and more particularly, to a high-strength sandwich panel including an embedded insert for supporting a high-weight load.

Conventional sandwich panels commonly used in the construction of aircraft interior walls and partitions preferably have a high strength and light weight. Such panels are typically constructed by adhesively bonding face sheets to opposite sides of a core material, for example, an aramid core. Sandwich panels may include additional internal layers to provide further strength and optimize the distribution of applied loads.

When mounting a high-weight load to a conventional sandwich panel, for example an attendant seat, it is critical that the panel be able to support the weight of the seat, the occupant and additional loading without damage or deformation to the panel. One conventional method of attaching a structure to a sandwich panel includes drilling holes in the panel and inserting fastener-receiving anchors. This method, although suitable for light loads, compromises the structural integrity of the panel and is incapable of adequately distributing high loads through the panel.

Accordingly, what is needed is a sandwich panel construction configured to distribute applied loads into the fiber-reinforcement plies of the panel, thus uniformly distributing applied loads to the sandwich panel field area.

### BRIEF SUMMARY OF THE INVENTION

In one aspect, a panel insert for being embedded within an aircraft interior panel to provide a high-strength panel is provided herein.

In another aspect, an aircraft interior sandwich panel including an embedded insert for providing a high-strength panel is provided herein.

In another aspect, the panel is configured to support a high-weight load.

In another aspect, the insert is configured to receive a fastener for attaching a load to the panel and to distribute high loads through the panel.

In another aspect, the insert is embedded within the panel beneath decorative facings of the panel.

These and other aspects are met by the present invention, which according to one embodiment provides an aircraft interior panel including a core panel sandwiched between structural plies, a panel insert embedded within the aircraft interior panel and configured for receiving a fastener for attaching a load to the aircraft interior panel, the panel insert passing through and interrupting the core panel, the insert having an elongate stem capped on each end with an enlarged flange, the elongate stem being arranged axially perpendicular to the core panel and the enlarged flanges being arranged parallel to the core panel, and facing sheets bonded outward of the panel insert for concealing the panel insert within the aircraft interior panel.

In another embodiment, the panel insert is tied to the core panel with at least one of potting compound, reinforcing fiberglass layers and aramid yarns circumferentially surrounding the stem.

In another embodiment, the aircraft interior panel includes circular, fiber-reinforced doubler plies arranged above and below outward of the core panel and parallel thereto and circumferentially surrounding the stem. The structural plies above and below the core panel can be sandwiched between the circular, fiber-reinforced doubler plies. The structural plies above and below the core panel can include a plurality of structural plies oriented at varying orientations to optimize distribution of the load through the aircraft interior panel. The plurality of structural plies and outwardly arranged doubler plies can be arranged at varying orientations at can have varying directional weaves, for example, 0°, 45° and 90°.

In another embodiment, depending on the configuration of the applied load, the aircraft interior panel can include a plurality of spaced panel inserts, each of the spaced panel inserts including doubler plies in the panel field area of the inserts.

In another embodiment, the panel insert can include two halves parts that press together to engage a locking feature for preventing the parts from being pulled apart. The two parts of the panel insert can include a female half and a male half that engages within the female half. The male and female halves, when engaged, sandwich the core panel, the structural plies and the doubler plies between the enlarged flanges.

In another embodiment, the panel insert defines an internally threaded axial bore for receiving an externally threaded fastener therein. The enlarged flanges can have a circular or plate shape.

In another embodiment, the aircraft interior panel can include adhesive film, such as adhesive film positioned between the outward surface of the enlarged flanges and the facing sheets for facilitating bonding therebetween.

In another embodiment, the core panel can be an aramid or honeycomb material.

Additional features, aspects and advantages of the invention will be set forth in the detailed description which follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### BRIEF DESCRIPTION OF THE DRAWINGS

Features, aspects and advantages of the invention are understood when the following detailed description of the invention is read with reference to the accompanying drawings, in which:

FIG. 1 is a schematic diagram of a high-strength panel including an embedded insert according to an embodiment of the invention;

FIG. 2 is a sectional view through the thickness of the panel of FIG. 1;

FIG. 3A shows one side of a panel insert;

FIG. 3B shows the opposing side of the insert of FIG. 3A;

FIG. 3C is a sectional view through the insert of FIGS. 3A and 3B;

FIG. 4 shows the female part of another embodiment of a panel insert; and

FIG. 5 shows the male part for matingly engaging with the female part of FIG. 4.

### DETAILED DESCRIPTION OF THE INVENTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention.

Referring to the figures, a high-strength panel for use in an aircraft interior or other application is shown generally at reference numeral 10. The aircraft interior panel 10 is configured for use in interior walls and panels to which a high-weight load is attached, for example an attendant seat. The aircraft interior panel 10 provided herein includes an embedded panel insert 12 and multi-ply or multi-layered constructed configured to optimally react to an applied load and distribute the applied load into the adjacent fiber-reinforcement plies of the aircraft interior panel 10. The panel insert 12 is concealed from view beneath facing sheets 14, such as decorative facing plies, of the aircraft interior panel 10 for aesthetic reasons, among other reasons. A single aircraft interior panel 10 can include a plurality of spaced panel inserts 12 for attaching multiple loads to the panel or aligning with multiple attachment points of a high-weight load, for example an attachment bracket of an attendant seat.

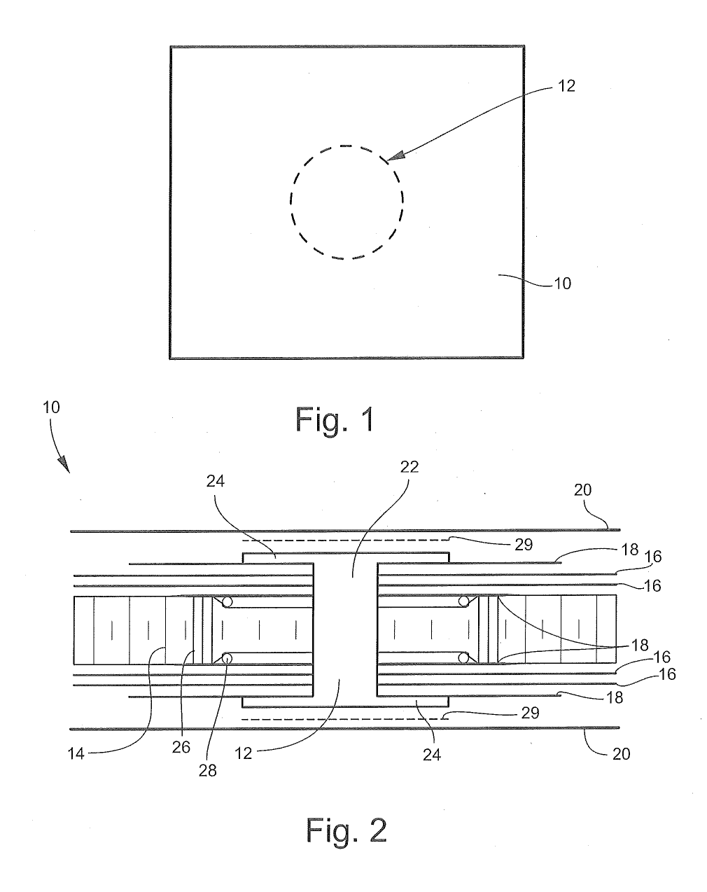

Referring to FIG. 1, a portion of a major face of an aircraft interior panel 10 is shown with the embedded panel insert 12 shown in broken lines to indicate its position beneath the facing sheet of the aircraft interior panel 10.

Referring to FIG. 2, a sectional view through the aircraft interior panel 10 and panel insert 12 of FIG. 1 illustrates the multi-layered arrangement of the aircraft interior panel 10 and embedding of the panel insert 12 therein. The aircraft interior panel 10 includes a core panel 14 sandwiched between a plurality of structural plies 16. The core panel 14 comprises a substantial portion of the thickness of the aircraft interior panel 10 and can be an aramid core panel, honeycomb panel or like panel that is preferably lightweight and fire retardant. The structural plies 16, or structural layers, are arranged above and below the core panel 14 and are parallel to the core panel 14 and run coextensive with the core panel 14.

The structural plies 16 can include any number of plies above and below the core panel 14 and are preferably oriented at varying orientations to optimize distribution of the load through the aircraft interior panel. The structural plies 16 can have varying orientations and directional weaves, for example 0°, 45° and 90°. The structural plies 16 above and below the core panel 14 are sandwiched between doubler plies 18 that can be oriented at varying orientations and can have different diameters. As used herein, the terms “doubler ply” and “doubler plies” can refer to a ply including fibers dispersed within a resin body.

The panel field area includes doubler plies 18 located in the area of each panel insert 12, while the structural plies 16 may extend throughout the entirety of the panel field area. The aircraft interior panel 10 is faced with facing plies 20 as the outermost layer that conceals the embedded panel insert 12.

The panel insert 12 is configured for receiving a fastener for attaching a load to the aircraft interior panel 10. The panel insert 12 generally includes an elongate, cylindrical stem 22, capped at each end in an enlarged flange 24. As shown, the enlarged flanges 24 are circular or disk-shaped, although the enlarged flanges can have any shape. The cylindrical stem 22 of the panel insert 12 passes through and interrupts the core panel 14, structural plies 16 and doubler plies 18. The enlarged flanges 24 having an outer diameter greater than that of the stem 22 and sandwich the doubler plies 18, structural plies 16 and core panel 14 therebetween.

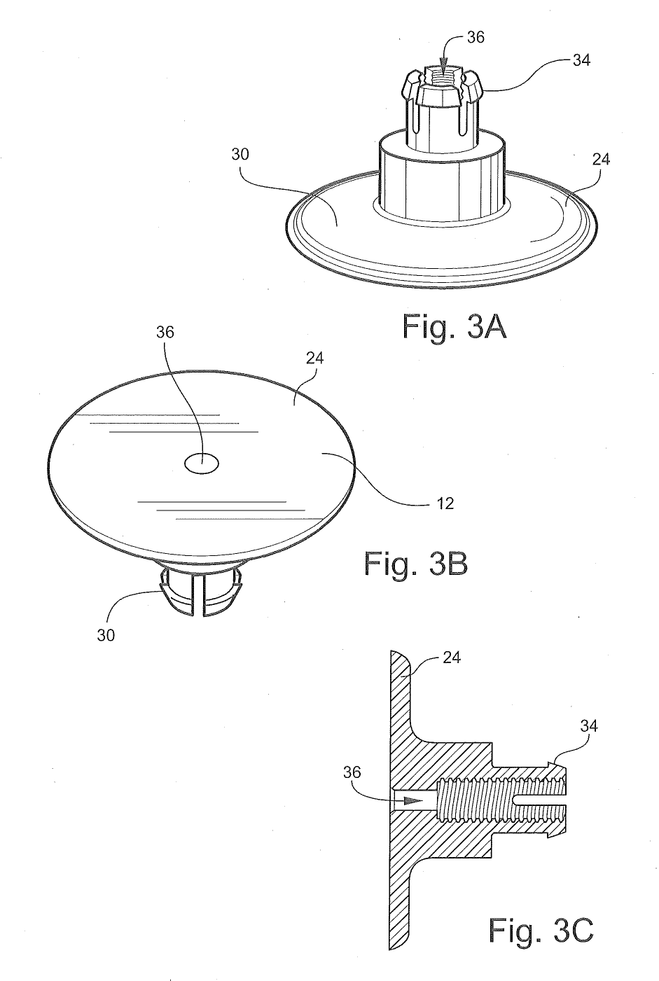

The panel insert 12 can have a two-part construction in which the parts are brought together through the plies and the core panel 14 and press together to engage a locking feature to prevent the two parts from being pulled apart. Referring to FIGS. 3A-5, which are described below in further detail, the two parts may include a female part and a male part that engages within the female part to lock the two parts together and sandwich the plies and core panel 14 therebetween.

The panel insert 12 is arranged within the aircraft interior panel 10 with the stem 22 arranged axially perpendicular to the core panel 14 and the enlarged flanges being arranged parallel to the core panel 14. At least one of the inside and outside edges of the enlarged flanges 24 can be sanded or chamfered to a smooth radius to resist tearing through the plies 16, 18 or facing sheets 20.

The panel insert 12 is tied to the core panel 14 with at least one of potting compound 26, the reinforcing fiberglass layers and aramid yarns 28 circumferentially surrounding the stem 22 to maintain the structural integrity of the aircraft interior panel 10. Adhesive film 29 can be applied to the outward surface of the enlarged flanges 24 to promote bonding between the enlarged flanges 24 and the facing sheets 20. Adhesive film may be used within the aircraft interior panel 10 in other arrangements to promote bonding between any of the core panel 14, structural plies 16, doubler plies 18, facing sheets 20 and panel insert 12.

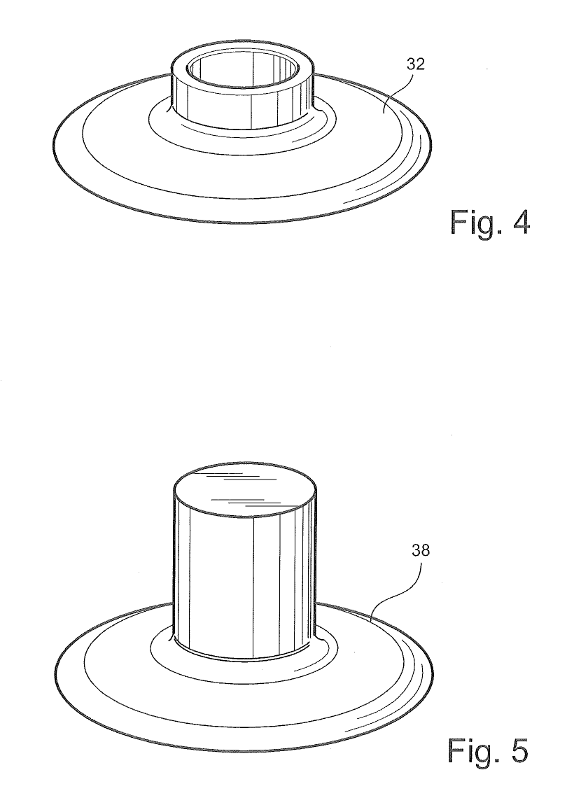

Referring to FIGS. 3A-4, the panel insert 12 is a two-part insert including a male half 30 and a female half 32. The male half 30 and the female half 32 are pressed together to lockingly engage to prevent being pulled apart. The male half 30 includes inwardly radially compressible tabs 34 terminating in protrusions that catch when slid over complimentary catches within the bore defined by the female half 32 of the panel insert 12. As shown in the combination of FIGS. 3A and 3B, the male half 30 defines an internally threaded axial bore 36 that opens through the outward face of the enlarged flange 24 for receiving an externally threaded fastener therein, for example a screw for attaching a load to the aircraft interior panel 10. The fastener may turn to advance through the male half 30 into the female half 32 to further lock the male and female halves 30, 32 together. As shown in FIG. 3C, the internal threading may extend only a portion of the length of the bore 36.

Referring to FIG. 5, another embodiment of a male half for engaging within the female half 32 of FIG. 34 is shown at reference numeral 38. The bore (not shown) of male half 38 may not extend the full length of its stem. Regardless of the panel insert configuration, the stem can have any length or diameter, and preferably has a lesser diameter than the outer diameter of the enlarged flanges 24.

While a high-strength aircraft interior panel has been described with reference to specific embodiments and examples, it is intended that various details of the invention may be changed without departing from the scope of the invention. Furthermore, the foregoing description of the preferred embodiments of the invention and best mode for practicing the invention are provided for the purpose of illustration only and not for the purpose of limitation.

What is claimed is:

1. An aircraft interior panel, comprising:
a core panel sandwiched between structural plies;
a panel insert embedded within the aircraft interior panel and configured for receiving a fastener for attaching a load to the aircraft interior panel, the panel insert passing through and interrupting the core panel, the panel insert having an elongate stem capped on each end with an enlarged flange, the elongate stem being arranged axially perpendicular to the core panel and the enlarged flanges being arranged parallel to the core panel; and
facing sheets bonded outward of the panel insert for concealing the panel insert within the aircraft interior panel.

2. The aircraft interior panel according to claim 1, wherein the panel insert is tied to the core panel with at least one of potting compound, reinforcing fiberglass layers and aramid yarns circumferentially surrounding the stem.

3. The aircraft interior panel according to claim 1, further comprising at least one circular, fiber-reinforced doubler ply arranged outward of the core panel and parallel thereto and circumferentially surrounding the stem.

4. The aircraft interior panel according to claim 1, wherein the structural plies above and below the core panel are sandwiched between circular, fiber-reinforced doubler plies.

5. The aircraft interior panel according to claim 1, wherein the structural plies above and below the core panel include a plurality of structural plies oriented at varying orientations to optimize distribution of the load through the aircraft interior panel.

6. The aircraft interior panel according to claim 5, wherein the plurality of structural plies and a plurality of outwardly arranged doubler plies are oriented at varying orientations and have different directional weaves with respect to adjacent ones of structural plies and doubler plies.

7. The aircraft interior panel according to claim 1, further comprising a plurality of spaced panel inserts, each of the plurality of spaced panel inserts including doubler plies in the panel field area of the panel inserts.

8. The aircraft interior panel according to claim 1, wherein the panel insert includes two halves that press together to engage a locking feature for preventing the two halves from being pulled apart.

9. The aircraft interior panel according to claim 8, wherein the two halves include a female half and a male half that engages within the female half.

10. The aircraft interior panel according to claim 9, wherein the male and female halves, when engaged, sandwich the core panel, the structural plies and doubler plies between the enlarged flanges.

11. The aircraft interior panel according to claim 1, wherein the panel insert defines an internally threaded axial bore for receiving an externally threaded fastener therein.

12. The aircraft interior panel according to claim 1, wherein the enlarged flanges are circular.

13. The aircraft interior panel according to claim 1, further comprising adhesive film applied to the outward surface of the enlarged flanges for adhesively bonding the facing sheets to the enlarged flanges.

14. The aircraft interior panel according to claim 1, wherein the core panel is an aramid or honeycomb material.

15. An aircraft interior panel, comprising:
a core panel sandwiched between a plurality of structural plies;
a panel insert embedded within the aircraft interior panel and tied to the plurality of structural plies, the panel insert having an elongate stem capped on each end with an enlarged flange, the elongate stem being arranged axially perpendicular to the core panel and the enlarged flanges being arranged parallel to the core panel; and
facing sheets bonded outward of the panel insert for concealing the panel insert within the aircraft interior panel.

16. The aircraft interior panel according to claim 15, wherein the plurality of structural plies include fiber-reinforced doubler plies arranged outward of the core panel and parallel thereto and circumferentially surrounding the stem.

17. The aircraft interior panel according to claim 15, wherein the plurality of structural plies are sandwiched between fiber-reinforced doubler plies.

18. The aircraft interior panel according to claim 15, wherein the plurality of structural plies are oriented at varying orientations and have different directional weaves.

19. The aircraft interior panel according to claim 15, wherein fiber-reinforced doubler plies are located in the panel field area of the panel insert.

20. The aircraft interior panel according to claim 15, wherein the panel insert is constructed from two parts that press together through the core panel to lock together to prevent from being pulled apart, and wherein the panel insert defines an internally threaded axial bore for receiving an externally threaded fastener therein.
